(19) United States
(12) Patent Application Publication
(10) Pub. No.: US 2016/0083890 A1
(43) Pub. Date: Mar. 24, 2016

(54) LOWER BALANCER OF A WASHING MACHINE

(71) Applicant: Dongbu Daewoo Electronics Corporation, Seoul (KR)

(72) Inventor: Yoon Sung SHIN, Incheon (KR)

(21) Appl. No.: 14/567,316

(22) Filed: Dec. 11, 2014

(30) Foreign Application Priority Data
Sep. 22, 2014 (KR) 10-2014-0125821

(51) Int. Cl. D06F 37/24; F16F 7/10; D06F 17/06

(52) U.S. Cl. CPC D06F 37/245; D06F 17/06; F16F 7/1034

(57) ABSTRACT

Mechanism of maintaining balance of a washing machine during operation thereof. A lower balancer is coupled to a lower portion of the inner tub of the washing machine. The lower balancer has a receptacle for temporarily retaining washing water. During rotation of the inner tub, the retained water moves laterally within the lower balancer and presses an “L shaped” balancing side wall member in the direction of centrifugal force. Once the rotation stops, retained water drains automatically from the lower balancer.

### CROSS-REFERENCE TO RELATED APPLICATIONS

This application claims priority to Korean Patent Application No. 10-2014-0125821, filed on Sep. 22, 2014, with the Korean Intellectual Property Office, the disclosure of which is incorporated herein in its entirety by reference.

### TECHNICAL FIELD

The present disclosure relates to washing machine and washing method, and more particularly, to rotation balance mechanism of washing machine.

### BACKGROUND

In general, a washing machine is an apparatus that eliminates foreign matter or substances on or in laundry by agitating and/or rotating water and the laundry. A washing machine typically uses a motor and performs washing, rinsing, and spin-drying processes to clean the laundry.

Washing machines may be classified into types including cylinder type washing machines, agitator type washing machines, and pulsator type washing machines. A pulsator type washing machine washes the laundry using water flow generated by motion (e.g., rotation) of a pulsator in a washing tub.

Basically, a pulsator type washing machine includes an outer tub to store water, a drum (or a basket) to contain the laundry, and a drive motor disposed below the outer tub to rotate the drum. The drum is an inner tub disposed inside the outer tub.

A hydraulic balancer mounted at an upper side of the drum is used to reduce vibration caused by eccentricity resulting from unbalanced distribution of the laundry load.

However, in a conventional washing machine, a hydraulic balancer is mounted only at the upper side of the drum. As a result, undesirable vertical vibration at a lower side of the drum is not effectively reduced due to an unbalanced distribution of the laundry load.

In a case in which a balancer is also mounted at the lower side of the drum, in order to solve this problem, the weight of the washing tub as well as the overall weight of the washing machine is undesirably increased. Moreover, other components of the washing machine, such as the drive motor for operating the washing tub and the suspension system, have to be substantially redesigned to accommodate the lower balancer.

### SUMMARY

It would be advantageous to provide a mechanism and method to maintain balance at both the upper and lower sides of a washing tub without introducing significant weight increase.

Accordingly, an exemplary embodiment of the present disclosure provides a washing machine including: an outer washing tub which stores washing water; an inner washing tub which is positioned inside the outer washing tub and has water holes formed therein; a drive unit which rotates the inner washing tub; and a lower balancer which is formed at a lower side of the inner washing tub, which stores a part of the washing water and maintains balance of the inner washing tub when the inner washing tub is rotated.

The washing water which is used to maintain balance at the lower side of the inner washing tub may be drained to the outside when the inner washing tub is stopped, or when the rotation is stopped.

The lower balancer may include a water remaining portion having a container shape which is opened upward and stores a part of the washing water, and a balancing side wall portion which is formed outside the water remaining portion in a direction of centrifugal force, and has a drain port that is formed at a lower side of the balancing side wall portion in a direction toward a rotation center of the inner washing tub.

In one embodiment, the balancing side wall portion may include an “L”-shaped cross section.

A height of an outer wall body of the water remaining portion may be greater than a height of an inner wall body of the water remaining portion.

The washing machine may further include an upper balancer which is formed at an upper side of the inner washing tub.

Another exemplary embodiment of the present disclosure provides a washing method which includes a process of spin-drying laundry by rotating an inner washing tub, the washing method including: storing a part of the washing water at a lower side of the inner washing tub; maintaining balance at the lower side of the inner washing tub by moving the stored washing water from the lower side of the inner washing tub in a lateral direction by centrifugal force when the inner washing tub is rotated; and draining the washing water, which is moved from the lower side of the inner washing tub in the lateral direction, by gravity when the rotation of the inner washing tub is stopped.

Balance at upper and lower sides of the inner washing tub may be dually maintained when the inner washing tub is rotated, by maintaining balance at the upper side of the inner washing tub at all times.

According to the exemplary embodiment of the present disclosure, the washing machine and the washing method may advantageously maintain balance at both the upper and lower sides of the washing tub, and minimize an increase in overall weight of the washing tub.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a cross-sectional view of an exemplary washing machine including a lower balancer according to an exemplary embodiment of the present disclosure;

FIG. 2 is a cross-sectional view illustrating an exemplary lower balancer used in the washing machine of FIG. 1;

FIGS. 3, 4 and 5 are cross-sectional views sequentially illustrating operational states of the washing machine according to the exemplary embodiments of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Lower Balancer of a Washing Machine

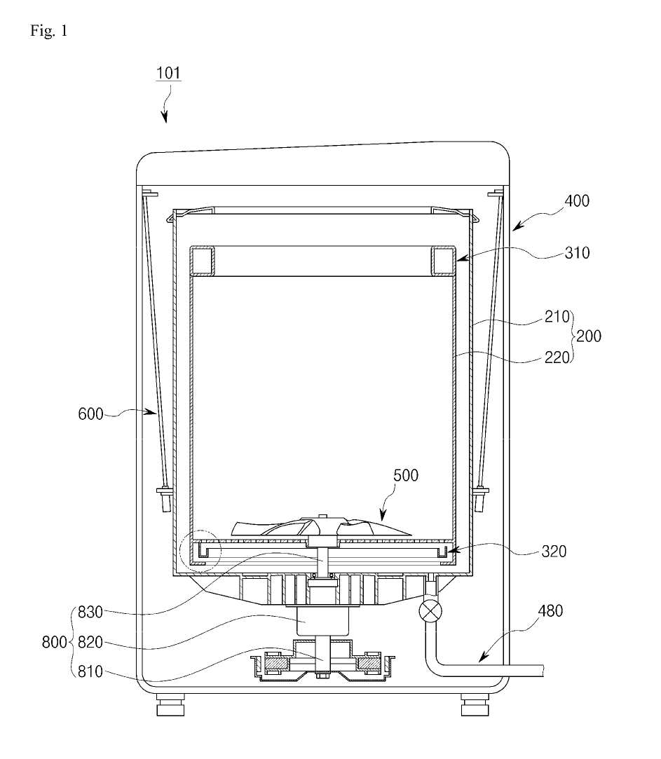

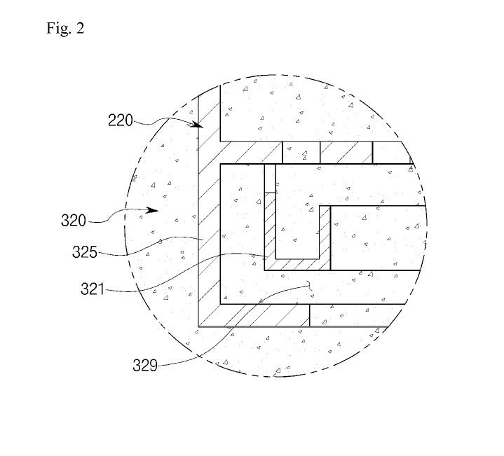

Hereinafter, a washing machine 101 according to an exemplary embodiment of the present disclosure will be described with reference to FIGS. 1 and 2.

As illustrating in FIG. 1, the washing machine 101 according to the exemplary embodiment of the present disclosure includes an outer washing tub 210, an inner washing tub 220, a drive unit 800, and a lower balancer 320.

The washing machine 101 also includes an upper balancer 310, a drainage device 480, a pulsator 500, a casing 400, and a suspension system 600.

The casing 400 defines an exterior housing of the washing machine 101, and the outer washing tub 210 is installed inside the casing 400. The outer washing tub 210 stores washing water for laundry.

The inner washing tub 220 (e.g., a basket) is rotatably positioned inside the outer washing tub 210. The inner washing tub 220 has water holes for water to flow in and out of the inner washing tub 220.

The pulsator 500 is rotatably coupled to the bottom of the inner washing tub 220 and servers to agitate the water while it rotates.

The drive unit 800 drives the rotation of the pulsator 500 and the inner washing tub 220. More specifically, the drive unit 800 may include a drive motor 810, a driving shaft 830 coupled to the drive motor 810, and a clutch device 820 which may intermittently supply a rotational force to the driving shaft 830.

When the drive motor 810 rotates the pulsator 500 during a washing process, the pulsator 500 in turn agitates the washing water and the laundry contained in the inner washing tub 220.

When the drive motor 810 rotates the inner washing tub 220 during a spin-drying process, the laundry is spin-dried as the moisture is removed by centrifugal force.

When the washing process is completed, e.g., before the spin-drying process, the drainage device 480 drains the washing water from the outer washing tub 210 to the outside of the washing machine. The drainage device 480 may include a drain pipe coupled to the outer washing tub 210, and a control valve which opens and closes the drain pipe.

The upper balancer 310 is located at an upper side of the inner washing tub 220. It is appreciated that the upper balancer 310 is filled with a balance maintaining fluid. The balance maintaining fluid is retained in the upper balancer 310 and is not regularly discharged from the upper balancer 310.

According to the present disclosure, the lower balancer 320 is located at a lower side of the inner washing tub 220. The lower balancer 320 receives a part of the washing water, e.g., when the washing water is drained. Advantageously, the lower balancer 320 temporarily stores the part of the washing water as a balancing weight for maintaining balance of the inner washing tub 220, when the inner washing tub 220 is rotated, for example during a spin-dry process. When the rotation of the inner washing tub is stopped, the water is then drained from the lower balancer to the outside. That is, the washing water is not always retained in the lower balancer 320.

Specifically, as illustrated in FIG. 2, the lower balancer 320 may be annular-shaped overall and include a receptacle 321 to retain water and a balancing side wall portion 325.

In this example, the receptacle 321 and the balancing side wall portion 325 are annular-shaped, but the present disclosure is not limited thereto. For example, in some embodiments, a plurality of receptacles 321 and a plurality of balancing side wall portions 325 may be formed radially, e.g., in different radii relative to a rotation center of the inner washing tub 220.

The receptacle 321 is an annular groove formed by an inner upright wall, an outer upright wall and a horizontal bottom. The receptacle 321 opens upward so it can hold washing water. In this example, the outer annular wall of the receptacle 321 is coupled to a lower portion of the inner washing tub 220 and has an opening so the water can flow from the receptacle to the space formed between outer annular wall and the balancing side wall portion 325, as will be described below.

The balancing side wall portion 325 is formed outside the receptacle 321 along the direction of the centrifugal force. The balancing side wall portion 325 has an upright part having a larger radius than the outer upright wall of the receptacle 321. The balancing side wall portion 325 may have a drain port 329 (or draining opening) at a lower side of the balancing side wall portion 325 in a direction toward the rotation center of the inner washing tub 220. In this example, the balancing side wall portion 325 has an “L”-shaped cross section and includes the upright part and a horizontal part. The space between the receptacle 321 and the horizontal part of the side wall portion forms the drain port.

It is appreciated that the washing water stored in the receptacle 321 can flow to the balancing side wall portion 325 via the opening on the outer upright wall under the centrifugal force generated by the rotation of the inner washing tub 220. The washing water presses the balancing side wall portion 325 under the impact of the centrifugal force. Consequently, in accordance with embodiments of the present disclosure, the combination of the lower balancer 320 and the upper balancer 310 can advantageously maintain the balance of the inner washing tub 220 simultaneously at both the upper and lower sides, thereby attenuating the vibration more effectively than using merely an upper balancer.

In one embodiment, the height of the outer upright wall of the receptacle 321 is greater than the height of the inner upright wall of the receptacle 321, such that the washing water in the receptacle 321 only flows to the balancing side wall portion 325 when the inner washing tub 220 rotates at a predetermined speed or higher.

Accordingly, when the inner washing tub 220 rotates at such a speed that the washing water flowing to the balancing side wall portion 325 is not drained due to the centrifugal force but remains in the balancing side wall portion 325, the washing water in the receptacle 321 may flow to the balancing side wall portion 325.

In the exemplary embodiment of the present disclosure, the lower balancer 320 may be configured such that the balancing is only effectuated when the inner washing tub 220 rotates at a sufficiently high speed where the vibration becomes serious.

As described above, according to the exemplary embodiments of the present disclosure, the washing machine 101 can effectively advantageously attenuate vibration caused by the rotation of the inner washing tub 220.

As illustrated in FIG. 1, the suspension system 600 has one side coupled to the outer washing tub 200 and the other side coupled to the casing 400. The suspension system can further dampen the vibration of the outer washing tub 210 and the inner washing tub 220 caused by the rotation of the drive motor 810.

With the aforementioned configuration, the washing machine 101 according to the exemplary embodiments of the present disclosure can maintain balance of the inner washing tub 220 at both the upper and lower sides of the inner washing tub 220. At the same time, no significant product weight of the inner washing tub 220 as well as the washing machine 101 is introduced due to the addition of the lower balancer according to the present disclosure.

Hereinafter, a washing method using the washing machine 101 according to the exemplary embodiment of the present disclosure will be described with reference to FIGS. 2, 3, 4 and 5. In this case, the washing method includes a process of spin-drying laundry by rotating the inner washing tub 220.

First, as illustrated in FIG. 2, the outer washing tub 210 is filled with the washing water during a washing process. At the same time, the receptacle 321 of the lower balancer 320 is also filled with the washing water.

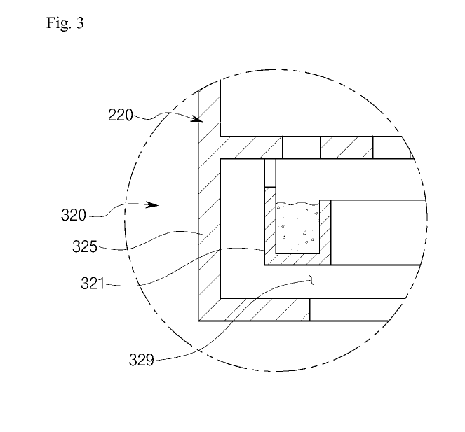

Next, as illustrated in FIG. 3, when the washing water in the outer washing tub 210 is drained through the drainage device 480, most of the washing water in the inner washing tub 220 is drained to the outside of the washing machine, but the receptacle 321 of the lower balancer 320 can retain some amount of the washing water.

That is, while the majority of the washing water is drained from the inner washing tub 210, some washing water is retained at the lower side of the inner washing tub 220 by the lower balancer 320.

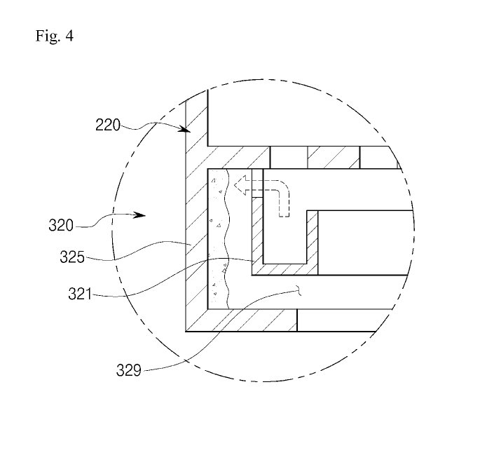

As illustrated in FIG. 4, when the inner washing tub 220 rotates and a spin-drying process begins, the washing water in the receptacle 321 moves to the balancing side wall 325 under the centrifugal force.

That is, the washing water stored at the lower side of the inner washing tub 220 moves from the lower side of the inner washing tub 220 in a lateral direction, thereby maintaining balance at the lower side of the inner washing tub 220.

Some washing water, which flows out during the spin-dry process, may move to the balancing side wall 325.

Due to the centrifugal force, the washing water moving to the balancing side wall 325 does not flow downward by gravity but is retained within the balancer. The retained washing water presses the balancing side wall 325 in the direction of centrifugal force, thereby maintaining balance at the lower side of the inner washing tub 220.

As described above, according to the exemplary embodiment of the present disclosure, the balance at both the upper and lower sides of the inner washing tub 220 can be maintained. That is, the vibration caused by the rotation of the inner washing tub 220 can be effectively attenuated during the spin-drying process.

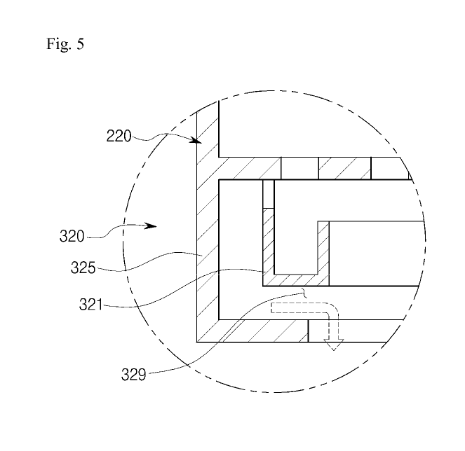

Next, as illustrated in FIG. 5, when the spin-drying process is finished and the rotation of the inner washing tub 220 is stopped, the washing water, which has moved from the lower side of the inner washing tub 220 in the lateral direction, is drained downward by gravity. Specifically, as the centrifugal force disappears, the washing water lodged the balancing side wall 325 drains through the drain port 329.

With the aforementioned process, the washing method using the washing machine 101 according to the exemplary embodiments of the present disclosure can maintain balance of the inner washing tub 220 at both the upper and lower sides of the inner washing tub 220, without introducing significant product weight of the washing machine 101.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A washing machine comprising:
an outer washing tub configured to retain washing water;
an inner washing tub disposed inside the outer washing tub and configured to hold laundry, wherein the inner washing tub comprises water holes formed thereon;
a drive unit configured to drive the inner washing tub to rotate; and
a lower balancer comprising a receptacle and configured to retain a portion of the washing water in the receptacle to maintain balance of the inner washing tub when the inner washing tub rotates, wherein the lower balancer is located at a lower side of the inner washing tub and adjacent to the drive unit.

2. The washing machine of claim 1, wherein the portion of the washing water retained in the receptacle drains from the lower balancer when the inner washing tub stops rotating.

3. The washing machine of claim 2, wherein the receptacle opens upward with reference to an orientation of the washing machine.

4. The washing machine of claim 2, wherein the lower balancer further comprises a balancing side wall portion disposed in a greater radial distance from a rotation center of the inner washing tub than the receptacle, and wherein a drain opening is formed between the balancing side wall portion and the receptacle.

5. The washing machine of claim 3, wherein the balancing side wall portion has an “L”-shaped cross section and comprises an upright part and a horizontal part, and wherein the portion of the washing water moves from the receptacle to the balancing side wall portion and presses the upright part to maintain balance of the inner washing tub during rotation of the inner washing tub.

6. The washing machine of claim 3, wherein the receptacle is a ring-shaped groove comprising an inner upright wall and an outer upright wall, and wherein further the outer upright wall is higher than the inner upright wall.

7. The washing machine of claim 1, further comprising an upper balancer disposed at an upper side of the inner washing tub.

8. The washing machine of claim 1, wherein the lower balancer is configured to maintain balance of the inner washing tub when the inner washing tub rotates above a predetermined speed.

9. The washing machine of claim 4, wherein the lower balancer comprises a plurality of additional receptacles and a plurality of additional balancing side wall portions distributed in various distances from the rotation center of the inner washing tub.

10. A washing method including a spin-drying process by rotating an inner washing tub of a washing machine, the washing method comprising:
automatically rotating the inner washing tub, wherein washing water is retained at a lower balancer of the inner washing tub during rotation of the inner washing tub; and maintaining balance of a lower side of the inner washing tub, wherein retained washing water is operable to maintain the balance at a lower side of the inner washing tub during the rotation, wherein the lower balancer is configured such that the retained washing water moves from the lower side of the inner washing tub in a lateral direction under centrifugal force during the rotation of the inner washing tub.

11. The washing method of claim 9 further comprising:
automatically stopping rotation of the inner washing tub, wherein the stopping causes the retained washing water to drain from the lower balancer by gravity.

12. The washing method of claim 10 further comprising maintaining balance at an upper side of the inner washing tub during the rotation of the inner washing tub.

13. A lower balancer of a washing machine, the lower balancer comprising:
a receptacle member coupled to a lower portion of an inner washing tub of the washing machine, and operable to retain washing water, wherein the receptacle member comprises an opening for water to flow through; and
a balancing side wall member disposed radially outwards from the receptacle, wherein retained washing water flows from the receptacle member towards the balancing side wall member in a lateral direction under centrifugal force during rotation of the inner washing tub.

14. The lower balancer of claim 13, wherein a space is formed between the receptacle member and the balancing side wall member, and wherein retained washing water automatically drains via the space when the rotation stops.

15. The lower balancer of claim 13, wherein the receptacle member and the balancing side wall member are annular shaped, and wherein the lower balancer is operable to maintain balance of the inner washing tub if the rotation is above a predetermined speed.

16. The lower balancer of claim 13, wherein the receptacle member comprises: an inner upright wall; an outer upright wall having a greater radius than the inner upright wall; and a bottom, and wherein the outer upright wall is taller than the inner upright wall.

17. The lower balancer of claim 13 further comprising a plurality of additional receptacle members and a plurality of additional balancing side wall members disposed in different radii from a center of rotation of the inner washing tub.

18. The lower balancer of claim 13, wherein the balancing side wall member has an “L” shape cross section and comprises an upright part and a horizontal part.
